(19) United States
(12) Patent Application Publication
(10) Pub. No.: US 2011/0020715 A1
(43) Pub. Date: Jan. 27, 2011

(54) FUEL CELL SYSTEM

(75) Inventors: Kazunobu Shinoda, Aichi-ken (JP); Keiji Suzumura, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidosha Kabushiki Kaisha, Toyota-shi, Aichi-ken (JP)

(21) Appl. No.: 12/922,638

(22) PCT Filed: Jan. 28, 2009
(86) PCT No.: PCT/JP2009/051326

§ 371 Date: Sep. 14, 2010

(30) Foreign Application Priority Data
Mar. 31, 2008 (JP) 2008-092339

(51) Int. Cl. H01M 8/06

(52) U.S. Cl. 429/410; 429/423

(57) ABSTRACT

[Problem] The object is to provide a fuel cell system capable of ventilating the interior of a casing in a simplified construction and also capable of suppressing the drawing of combustion gas into the interior of the casing even if such gas remains around the casing at the worst.

[Solution] The system comprises a reforming apparatus 21 for generating reformed gas from fuel gas, a fuel cell 11 capable of generating electric power with reformed gas and oxidizer gas, a cooling passage 80 opening to the outside of a casing 70 for leading cooling air which cools an interior of the casing, into a receiving space in the interior of the casing through an inverter system 15, an air blower 31 for introducing cooling air from the outside of the casing to the cooling passage, and a breaker for cutting off a circuit to a power line when the fuel cell system falls in abnormality or is to be subjected to maintenance, wherein the casing receives the reforming apparatus, the fuel cell, the inverter system, the air blower and the breaker in the receiving space and wherein cooling air introduced by the air blower from the outside of the casing is led to the receiving space after cooling the inverter system, whereby the pressure in the receiving space is kept higher than the atmospheric pressure.

### TECHNOLOGICAL FIELD

The present invention relates to a fuel cell system.

### BACKGROUND ART

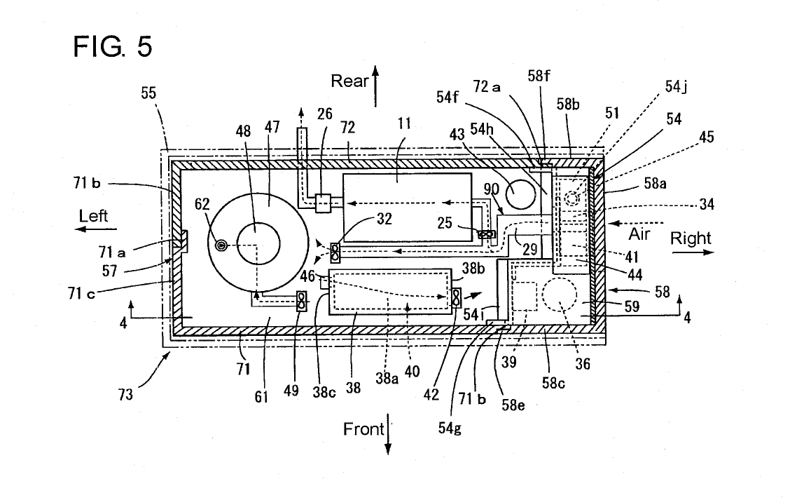

Heretofore, in order to lower the temperature in the interior of a casing covering a fuel cell system, as one measures for discharging to the outside of the casing combustible gas (e.g., hydrogen gas, city gas 13A or the like) remaining in the interior of a casing due to leak in the interior of the casing, there has been practiced a method of forced ventilation by a ventilation fan, of which one described in Patent Document 1 has been known for example. In the Patent Document 1, as shown in FIGS. 5-8, intake ports 83, 84 are provided on one surface constituting a casing, while an exhaust port 90 is provided together with an exhaust fan on another surface also constituting the casing. By rotationally driving the fan in such a direction as to discharge the air in the interior of the casing from the exhaust port to the outside, the exhaust fan lowers the pressure in the interior of the casing, whereby the outside air is led into the interior of the casing from the intake ports provided on the one surface constituting the casing and takes away the heat in the interior of the casing before being discharged to the outside of the exhaust port. As a result, the interior of the casing is always ventilated by flesh outside air being low in temperature, so that it is possible to prevent the temperature increase and the remaining of combustible gas such as hydrogen and the like in the interior of the casing.

### Patent Document 1: JP2006-140165 A

### DISCLOSURE OF THE INVENTION

### Problem to be Solved by the Invention

However, in the system described in the aforementioned Patent Document 1, because the interior of the casing is reduced in pressure during the ventilation operation, there is a likelihood that if the casing has an unpurposed clearance, the air outside of the casing is drawn into the casing through the clearance. Also in the embodiment of the Patent Document 1, since a desulfurizer 12 is provided outside of the casing, if fuel gas leaks from a connection portion between the desulfurizer 12 and a fuel gas pipe or from the desulfurizer 12 and if the casing has a clearance communicating with the interior of the casing around the leak portion, it is feared that the leaking fuel gas is drawn into the casing. Particularly, it is unfavorable that fuel gas remains around a breaker arranged in the interior of the casing and having a function of cutting off a circuit to a system power source at the time of an emergency.

The present invention has been made for solving the aforementioned problem in the prior art, and an object thereof is to provide a fuel cell system capable of ventilating the interior of a casing in a simplified construction and hence, of reducing the likelihood that fuel gas remains in the interior of the casing.

### Measures for Solving the Problem

In order to solve the foregoing problem, the feature in construction of the invention according to claim 1 resides in comprising a reforming apparatus for generating reformed gas from fuel gas, a fuel cell capable of generating electric power with reformed gas and oxidizer gas to supply output electric power to internal loads of a fuel cell system and external loads, a cooling passage opening to the outside of the casing for leading cooling air which cools the interior of the casing, into a receiving space in the interior of the casing through the inverter system, an air blower for introducing cooling air into the cooling passage from the outside of the casing, and a breaker for cutting off a circuit to the power line when the fuel cell system falls in abnormality or is to be subjected to maintenance, wherein the casing receives the reforming apparatus, the fuel cell, the inverter system, the air blower and the breaker in the receiving space and wherein the cooling air introduced by the air blower from the outside of the casing cools the inverter system to be led into the receiving space, whereby the pressure in the receiving space is kept higher than the atmospheric pressure.

The feature in construction of the invention according to claim 2 resides in comprising a reforming apparatus for generating reformed gas from fuel gas, a fuel cell capable of generating electric power with reformed gas and oxidizer gas to supply output electric power to internal loads of a fuel cell system and external loads, a ventilation passage opening to the outside of the casing for leading ventilation air which ventilates the interior of the casing, into a receiving space in the interior of the casing, an air blower for introducing ventilation air into the ventilation passage from the outside of the casing, and a breaker for cutting off a circuit to the power line when the fuel cell system falls in abnormality or is to be subjected to maintenance, wherein the casing receives the reforming apparatus, the fuel cell, the air blower and the breaker in the receiving space and wherein the ventilation air introduced by the air blower from the outside of the casing is led into the receiving space, whereby the pressure in the receiving space is kept higher than the atmospheric pressure.

The feature in construction of the invention according to claim 3 resides in that in claim 1 or 2, one end part of the receiving space is made as a manipulation section space in which the breaker is arranged, that a maintenance space receiving a desulfurizer for removing odor ingredient of the fuel gas is formed at the one end part in the interior of the casing to be adjacent to the manipulation section space in isolation from the receiving space, and that a partition wall partitioning the manipulation section space and the maintenance space is provided with a discharge passage for discharging the air in the manipulation section space to the maintenance space.

The feature in construction of the invention according to claim 4 resides in that in claim 3, the manipulation section space is arranged over the maintenance space and that a maintenance panel covering the maintenance space is provided on the casing to be able to open and close.

### EFFECTS OF THE INVENTION

In the invention according to claim 1 as constructed above, the cooling air introduced by the air blower from the outside of the casing into the cooling passage cools the inverter system to be led into the receiving space in the interior of the casing. Thus, since the pressure in the receiving space becomes higher than the atmospheric pressure and since the air in the receiving space is discharged to the outside of the casing through a clearance of the casing serving as a discharge passage, it is possible to reduce the likelihood that the fuel gas remains in the receiving space in the interior of the casing.

In the invention according to claim 2 as constructed above, the ventilation air introduced by the air blower from the outside of the casing into the ventilation passage is led into the receiving space in the interior of the casing. Thus, since the pressure in the receiving space becomes higher than the atmospheric pressure and since the air in the receiving space is discharged to the outside of the casing through a clearance of the casing serving as a discharge passage, it is possible to reduce the likelihood that the fuel gas remains in the receiving space in the interior of the casing.

In the invention according to claim 3 as constructed above, the partition wall which partitions the manipulation section space with the breaker arranged therein of the receiving space in the interior of the casing and the maintenance space receiving the desulfurizer for removing odor ingredient of fuel gas is provided with the discharge passage for discharging the air in the manipulation section space to the maintenance space. Thus, the flow of air can be made from the manipulation section space to the maintenance space, so that it is possible to reduce the likelihood that fuel gas remains around the breaker. Accordingly, it is possible to reduce the likelihood that fuel gas remains in the manipulation section space as a result that, for example, the fuel gas leaked from a fuel gas pipe is drawn into the manipulation section space.

In the invention according to claim 4 as constructed above, since the manipulation section space with the breaker arranged therein is provided over the maintenance space receiving the desulfurizer which removes odor ingredient of fuel gas, the manipulation of the breaker at the time of maintenance and the protection of the breaker become easy. Further, although the maintenance space is covered by the maintenance panel which is able to open and close on the casing, the flow of air from the manipulation section space to the maintenance space makes it possible to reduce the likelihood that fuel gas remains around the breaker.

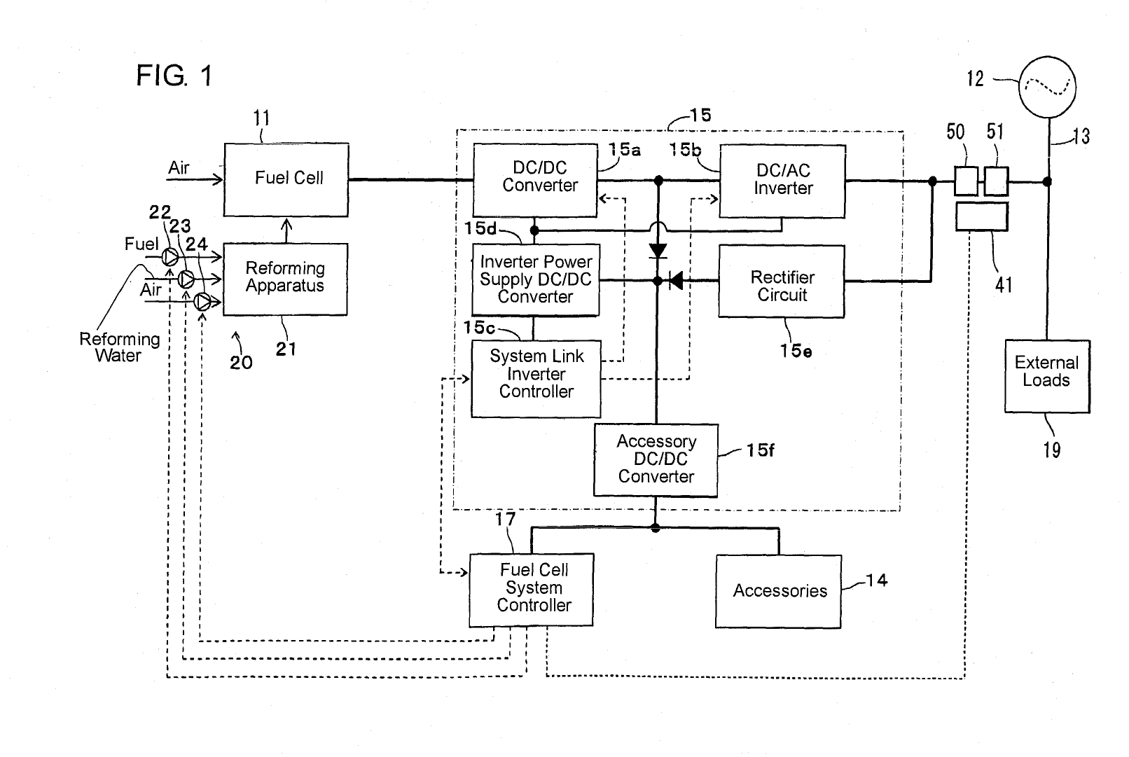

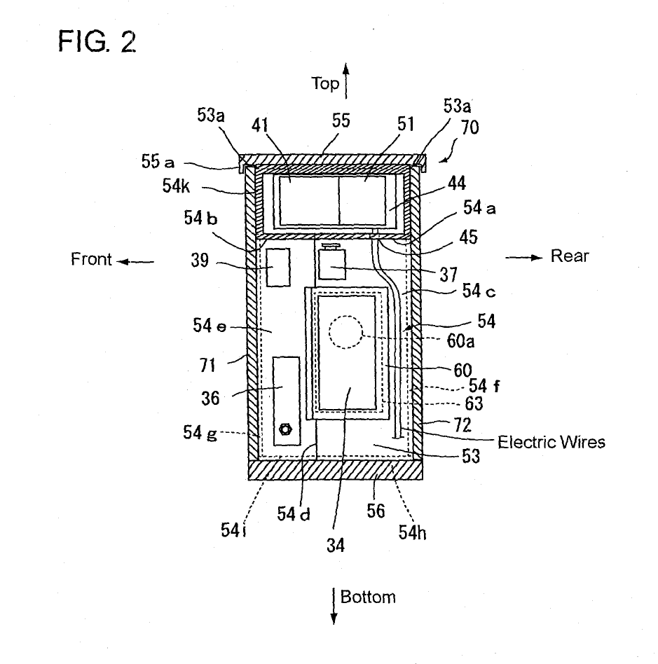

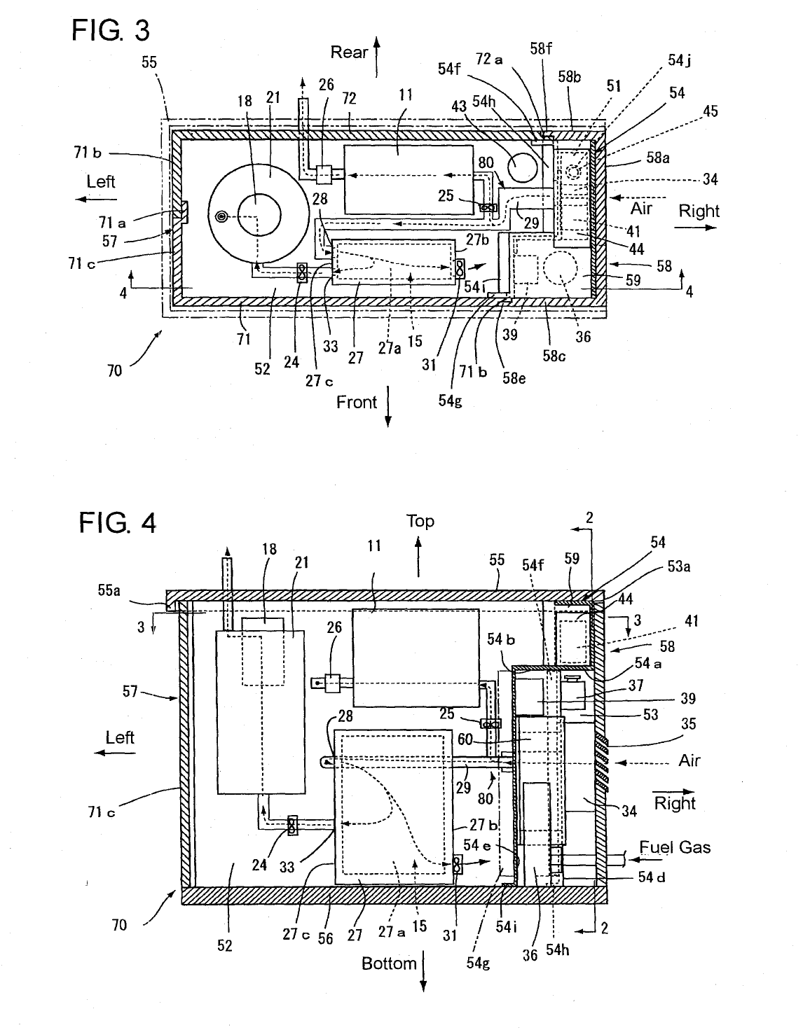

### BRIEF DESCRIPTION OF THE DRAWINGS

[FIG. 1] is a constructional block diagram showing the construction of a fuel cell system in one embodiment according to the present invention.

[FIG. 2] is a right side sectional view of a casing 70 of the fuel cell system in a first embodiment.

[FIG. 3] is a top sectional view of the casing 70 of the fuel cell system in the first embodiment.

[FIG. 4] is a front sectional view of the casing 70 of the fuel cell system in the first embodiment.

[FIG. 5] is a top sectional view of a casing 73 of a fuel cell system in a second embodiment.

### DESCRIPTION OF REFERENCE SYMBOLS

11 . . . fuel cell, 12 . . . system power source, 13 . . . power line, 14 . . . accessories (internal loads), 15 . . . inverter system, 17 . . . fuel cell system controller, 19 . . . external loads, 21 . . . reforming apparatus, 27 . . . inverter box, 29 . . . duct, 31 . . . air blower, 32 . . . air blower, 34 . . . air filter, 35 . . . air inlet port, 38 . . . inverter box, 40 . . . inverter system, 42 . . . air blower, 51 . . . breaker, 52 . . . receiving space, 53 . . . maintenance space, 54 . . . partition wall, 58 . . . maintenance panel, 61 . . . receiving space, 70 . . . casing, 73 . . . casing, 80 . . . cooling passage, 90 . . . ventilation passage.

### Form for Practicing the Invention

Hereafter, a first embodiment of a fuel cell system according to the present invention will be described with reference to the drawings. FIG. 1 is a constructional block diagram showing the construction of the fuel cell system. The fuel cell system is composed of a fuel cell 11, a system power source 12, a power line 13, accessories 14, an inverter system 15, a fuel cell system controller 17, a reforming apparatus 21, a maintenance control board 41, and a breaker 51. It is to be noted that terms “front”, “rear”, “left”, “right”, “top” and “bottom” in the description mean as represented in the drawings.

The fuel cell 11 is supplied with hydrogen-rich reformed gas and oxidizer gas (e.g., oxygen-containing air) and generates electric power through the reaction of hydrogen and oxygen to output direct current voltage (e.g., 40 volts).

The reforming apparatus 21 steam-reforms the fuel gas to supply the fuel cell 11 with hydrogen-rich reformed gas and is composed of a burner (combustion section) 18, a reforming section, a carbon monoxide shift reaction section (hereafter referred to as “CO shift section”) and a carbon monoxide selective oxidization section (hereafter referred to as “CO selective oxidization section”). As the fuel gas, there may be employed natural gas, LPG, gasoline, methanol or the like. The burner 18 is supplied with combustion fuel gas and combustion air from the outside at the time of an operation start or is supplied with anode offgas (reformed gas supplied to the fuel cell but exhausted without being consumed) from a fuel electrode of the fuel cell 11 at the time of an ordinary operation, wherein the burner combusts each supplied combustible gas and leads the combusted gas to the reforming section. A part of cooling air led to an inverter box 27 referred to later is branched as the combustion air from the interior of the inverter box and is supplied by an air pump 24. Further, the gas burned at the burner 18 is discharged outside through an exhaust pipe connected to an exhaust port of the reforming apparatus 21.

The reforming section reforms a mixture gas in which steam (reforming water) supplied from an evaporator is mixed with fuel gas supplied from the outside, through a catalyzer filled in the reforming section to generate hydrogen gas and carbon monoxide gas (a so-called steam reforming reaction). At the same time, the reforming section metamorphoses the carbon monoxide, generated through the steam reforming reaction, and steam into hydrogen gas and carbon dioxide (a so-called carbon monoxide shift reaction). The hydrogen-rich reformed gases so generated are discharged to the CO shift section.

The CO shift section reacts the carbon monoxide and the steam included in the reformed gas through a catalyzer filled inside thereof to metamorphose them into hydrogen gas and carbon dioxide gas. Thus, reformed gas is reduced in the density of carbon monoxide to be led to the CO selective oxidizing section.

The CO selective oxidizing section reacts carbon monoxide remaining in the reformed gas and CO purgation air further supplied form the outside through a catalyzer filled inside thereof to generate carbon dioxide. Thus, the reformed gas is further reduced (less than 10 ppm) in the density of carbon monoxide and is led to the fuel electrode of the fuel cell 11.

Fuel gas, reforming water (water) and air (for CO purgation) are respectively supplied by a fuel pump 22, a reforming water pump 23 and an air pump 24, and the supply quantities are controlled based on commands from the fuel cell system controller 17. By controlling the supply quantities from the fuel pump 22, the reforming water pump 23 and the air pump 24, it is possible to regulate the reformed gas supplied from the reforming apparatus 21.

The system power source (or commercial power supply) 12 supplies electric power to external loads 19 through the power line 13 connected to the system power source 12. The fuel cell 11 is connected to the power line 13 through the inverter system 15 and the breaker 51. The external loads 19 are power loads arranged outside of the fuel cell system and comprises household appliances such as, for example, TVs arranged in the home.

The accessories 14 being one kind of internal loads are constituted by respective motor-driven pumps 22-24 and electromagnetic valves for supplying the reforming apparatus 21 with fuel, water and air and electromagnetic valves for supplying the fuel cell 11 with reformed gas and air (oxygen). The accessories 14 are driven under direct current voltage, and the driving voltage is supplied from an accessory DC/DC converter 15f. The internal loads are power loads arranged in the fuel cell system and include the accessories 14 and the fuel cell system controller 17.

The inverter system 15 has a DC/AC inverter 15b which has a function of converting direct current voltage outputted from the fuel cell 11 into predetermined alternating current voltage to output the same to the power line 13 connected to the system power source 12 and another function of converting alternating current voltage from the power line 13 into predetermined direct current voltage, a rectifier circuit 15e and the accessory DC/DC converter 15f which have a function of converting alternating current voltage from the power line 13 into predetermined direct current voltage to output the same to the internal loads such as the accessories 14, the fuel cell system controller 17 and the like, and a DC/DC converter 15a which has a function of converting direct current voltage form the fuel cell 11 into predetermined direct current voltage to output the same to the internal loads.

A system link inverter controller 15c controls the driving of the DC/DC converter 15a and the DC/AC inverter 15b. The system link inverter controller 15c is connected to the fuel cell system controller 17 to be able to communicate with each other and controls the driving of the DC/DC converter 15a and the DC/AC inverter 15b in response to commands from the fuel cell system controller 17.

An inverter power supply DC/DC converter 15d has the direct current voltage inputted from the DC/DC converter 15a or the DC/AC inverter 15b and converts the direct current voltage into predetermined direct current voltage to output the same as power supply voltage (driving voltage) to the DC/DC converter 15a, the DC/AC inverter 15b and the system link inverter controller 15c.

The accessory DC/DC converter 15f has the direct current voltage inputted from the DC/DC converter 15a, the DC/AC inverter 15b or the rectifier circuit 15e and converts the direct current voltage into predetermined direct current voltage (e.g., 24 volts) to supply the same as power voltage to the accessories 14.

The inverter system 15 is received in the inverter box 27 and is fixed on a bottom surface of a casing 70 referred to later. The inverter box 27 is provided with an air inlet portion 28 for cooling the inverter system 15. The air inlet portion 28 is connected by a duct 29 to an air inlet port 35, which is provided at about the center part of a side surface 58a of a maintenance panel 58 arranged on a right side surface of the casing 70, through an air filter 34 which is in abutment with the inner side of the air inlet port 35 for removing dust or the like to supply clean air.

An air blower 31 communicating with the interior space 27a of the inverter box 27 is arranged at a lower part on a wall surface 27b of the inverter box 27, and with forward rotation of the air blower 31, air is introduced from the interior space 27a of the inverter box 27 into a receiving space 52 formed in the interior of the casing 70, whereby the internal pressure of the interior space 27a is lowered. As a result, clear air is drawn from the outside through the air inlet port 35. The air drawn into the interior space 27a of the inverter box 27 moves in the interior space 27a to cool the DC/AC inverter 15b, the rectifier circuit 15e, the accessory DC/DC converter 15f and DC/DC converter 15a which constitute the inverter system 15, through heat exchanges with respective control boards therefor and then is introduced by the air blower 31 into the receiving space 52.

Further, a part of clean outside air which is led for cooling to the inverter box 27 through the air filter 34 and the duct 29 is branched from a mid portion of the duct 29 and is supplied by a cathode blower 25 as oxidizer gas to the fuel cell 11. With respect to the air which was used for electric power generation after being supplied as oxidizer gas to an air electrode of the fuel cell 11, a part which was left without being used for electric power generation is discharged through an exhaust pipe which is connected to an exhaust port of the air electrode with a condenser 26 provided thereon, after being separated by the condenser 26 from water. An air outlet port 33 communicating with the interior space 27a of the inverter box 27 is provided on a wall surface 27c of the inverter box 27, and the air outlet port 33 is connected to the reforming apparatus 21 through the air pump 24, so that combustion air is supplied to the reforming apparatus 21.

The fuel system controller 17 is for performing overall control of the fuel cell system on a collectively concentrated basis and controls the driving of the accessories 14, controls the driving of the inverter system 15, and interacts with the maintenance control board 41 for delivery and receipt of fault information and signals for manipulating the system controller 17. The fuel cell system controller 17 is supplied with voltage at all times not only at the time of stand-by but also at the time of operation (including a start operation and a power generation operation).

The breaker 51, together with a noise filter 50 connected in series, is interposed between the system power source 12 (or the power line 13) and the DC/AC inverter 15b of the inverter system 15. In either of the cases that over current flows from the DC/AC inverter 15b and that an electric leakage occurs in the fuel cell system, the breaker device is operated to bring the power supply to the system into OFF and to cut off a circuit connected to the external loads, thereby protecting the external loads and the main part of the fuel cell system. Further, because of forming a circuit contact point which cuts off or connects the circuit, the breaker 51 is likely to spark. The breaker 51 and the maintenance control board 41 are received in side-by-side relation in a receiving box 44 opening at two sides which includes the side of respective manipulation sections on the breaker 51 and the maintenance control board 41 and the side opposite to the side of the respective manipulation sections, and are secured to the receiving box 44 by means of bolts (not shown).

Next, the casing 70 of the fuel cell system will be described with reference to FIGS. 2 through 4. The maintenance control board 41, the breaker 51, the fuel cell 11, the accessories 14, the inverter system 15, the fuel cell system controller 17 and the reforming apparatus 21 are received in the receiving space 52 of the casing 70, and the casing 70 is provided with an upper panel 55 at its upper part, a base panel 56 at its lower part, a front panel 71 at its front part and a rear panel 72 at its rear part. Further, a left side surface 57 is formed in such a way that the front panel 71 is bent to an L-shape to form about the half of the left side surface 57 at a shorter side portion 71c of the L-shape and that the rear panel 72 is bent to an L-shape to form the remaining half surface of the left side surface 57 at a shorter side portion 72b of the L-shape. As a right side surface, the right side surface 58a of the maintenance panel 58 is provided, whereby the receiving space 52 and a maintenance space 53 which is partitioned by a partition wall 54 from the receiving space 52 are formed inside of the casing 70.

The front panel 71 and the rear panel 72 are secured to the base panel 56 by means of bolts. Further, the front panel 71 and the rear panel 72 are provided at about the center of the left side surface 57 with a joint portion 71a which is formed by bending an end portion of the panel 71 to an L-shape toward the receiving space 52, and the joint portion is secured by means of bolts with the rear panel 72 engaged with the joint portion 71a. Then, the front panel 71 and the rear panel 72 are covered at their upper portions with the upper panel 55 having a brim portion 55a which hangs down from three edge portions at the front, rear and left, and the brim portion 55a is bodily secured to the front panel 71 and the rear panel 72 by means of bolts. Thereafter, in the aforementioned assembling state, the maintenance panel 58 taking about a U-shape is attached from the right side of the assembly. The maintenance panel 58 which mainly forms the right side surface is provided at front and rear sides with front and rear side walls 58c, 58b which respectively form parts of the front and rear surface portions of the casing 70, so that the casing 70 represents the shape of about a rectangular parallelepiped with the maintenance panel 58 attached to the casing.

At portions where the respective side walls 58c, 58b are engaged with the front panel 71 and the rear panel 72, respective end portions of the front panel 71 and the rear panel 72 are extended toward right as they keep the same surfaces as the inner surfaces of the front panel 71 and the rear panel 72, so that there are formed respective joint portions 71b, 72a which are formed to be thinner than the respective thicknesses of the front panel 71 and the rear panel 72. Further, respective end portions of the respective side walls 58c, 58b of the maintenance panel 58 are extended toward left as they keep the same surfaces as the outer surfaces of the respective side walls 58c, 58b, so that there are formed respective joint portions 58e, 58f which are formed to be thinner than respective thicknesses of the respective side walls 58c, 58b, and the respective joint portions 58e, 58f are respectively engaged with the respective joint portions 71b, 72a of the front panel 71 and the rear panel 72. Then, the maintenance panel 58 is secured by being secured by means of bolts to the partition wall 54 which is formed inside of the maintenance panel 58, from the right side surface 58a side of the casing 70, whereby the casing 70 is formed.

An upper end portion on the right of the receiving space 52 in the casing 70 is made as a manipulation section space 59 in which the maintenance control board 41 and the breaker 51 received in the receiving box 44 in a juxtaposed relation are arranged toward the outside of the right side surface 58a of the casing 70. The maintenance space 53 receiving replacement parts is provided under the manipulation section space 59 on the right side surface side of the casing 70 to be isolated from the receiving space 52 and is shielded from the outside by the maintenance panel 58 on the right side surface side.

As the partition wall 54 which partitions the receiving space 52 and the maintenance space 53, vertical walls 54c, 54d, 54e are provided on the right side surface side of the casing 70 to be vertically upright between the front panel 71 and the front panel 72, and the vertical walls 54c, 54d, 54e are provided at upper ends thereof with bottom walls 54a, 54b which form a bottom surface of the manipulation section space 59. Although isolating the maintenance space 53 from the receiving space 52 in this manner, the partition wall 54 does not air-tightly separate them by having a slight clearance therebetween and makes it hard for raindrops or the like to enter the receiving space 52.

Specifically, the partition wall 54 with a width slightly narrower than the distance between the front panel 71 and the rear panel 72 at the front and rear extends toward the right side surface as it contacts a lower surface of the upper panel 55 and hangs down on the side of the right side surface of the upper panel 55 to form a vertical wall 54k. With the manipulation section space 59 secured in which the receiving box 44 receiving the maintenance control board 41 and the breaker 51 is received, the vertical wall 54k is bent at right angle toward the receiving space 52 and horizontally extends as bottom walls through predetermined distances. At a position to which the bottom wall 54a is horizontally extended to secure a space capable of receiving a reservoir tank 37, the air filter 34 and the like and at another position to which the bottom wall 54b is horizontally extended to secure a space capable of receiving a desulfurizer 36 and an ion exchanger 39, the bottom walls 54a, 54b are bent downward at right angle to reach the base panel 56, so that the vertical walls 54c, 54d, 54e are formed. The vertical walls 54c, 54d, 54e are bent at lower end portions thereof toward the receiving space 52 each to take an L-shape. Thus, respective horizontal walls 54h, 54i are formed and are fastened at these bent portions to the base panel 56 at the lower part by means of bolts. Further, the vertical wall 54c is provided with a portion extended along the rear panel 72 side, the extended portion is bent at right angle toward the receiving space 52 to form a vertical wall 54f, and the bent portion is fastened to the rear panel 72 on the rear side by means of bolts. Further, the vertical wall 54e is provided with a portion extended along the front panel 71 side, the extended portion is bent at right angle toward the receiving space 52 to form a vertical wall 54g, and the bent portion is fastened to the front panel 71 on the front side by means of bolts.

At the center portion of the partition wall 54, a water refiner take-out window 63 for taking out a water refiner 43 being a replacement part arranged in the receiving space 52 is provided across the vertical walls 54c, 54d, 54e. The water refiner take-out window 63 is closed on the side of the right side surface of the partition wall 54 by a water refiner take-out cover 60 which is formed to be sufficiently larger than the water refiner take-out window 63, and the partition wall 54 and the water refiner take-out cover 60 are secured at an overlapping portion thereon by means of bolts.

A through hole 60a for leading air into the receiving space 52 is formed at about the center portion of the water refiner take-out cover 60, through which hole, air is led from the air inlet port 35 which is provided at about the center portion on the right side surface 58a of the maintenance panel 58. A cooling passage 80 which opens to the outside of the casing 70 for leading cooling air to the receiving space 52 in the casing 70 by way of the inverter system 15 is constituted by the air inlet port 35, the air filter 34, the through hole 60a, the duct 29, the interior space 27a of the inverter box 27 and the like. Further, the air blower 31 communicating with the interior space 27a of the inverter box 27 constitutes an air blower for introducing cooling air to the cooling passage 80 from the outside. Thus, the cooling air which is introduced by the air blower 31 from the outside of the casing 70 cools the inverter system 15 and then is led to the receiving space 52, so that the pressure in the receiving space 52 is kept higher than the atmospheric pressure.

Through holes 45 for enabling electric wires from the breaker 51 to pass therethrough are provided at a bottom surface of the receiving box 44 receiving the maintenance control board 41 and the breaker 51 as well as at a lower surface wall 54a of the partition wall 54 for the manipulation section space 59 in which the receiving box 44 is received and mounted. The electric wires are secured by a grommet at the through hole 45 of the lower surface wall 54a and extend to be connected to the power line 13 outside of the casing 70. Even in the state that the electric wires from the breaker 51 are secured by the grommet at the through hole 45, a clearance 54j which makes the receiving space 52 and the maintenance space 53 communicate with each other exists in the through hole 45. The clearance 54j constitutes a discharge passage formed on the partition wall 54 which isolates the manipulation section space 59 and the maintenance space 53, for discharging air in the manipulation section space 59 to the maintenance space 53.

The maintenance space 53 which is isolated by the partition wall 54 from the receiving space 52 is formed under the lower surface walls 54a, 54b of the partition wall 54 and receives therein the ion exchanger 39, the reservoir tank 37, the desulfurizer 36, the air filter 34 and the like which are replacement parts. The desulfurizer 36 is connected to a fuel gas supply (e.g., city gas pipe) and removes odor ingredient (e.g., sulfur compound) in fuel gas. After removal of the odor ingredient, fuel gas serving as unreformed fuel gas and combustion fuel gas is supplied to the reforming apparatus 21 by the fuel pump 22 which is provided upstream of the desulfurizer 36.

Next, description will be made regarding the operation of the fuel cell system as described above. During preparation for power generation (starting operation) of the fuel cell system, the fuel cell 11 is in a warm-up operation and is not generating electric power, and electric power is supplied from the system power source 12 to the fuel cell system.

During a power generation operation of the fuel cell system, the DC/DC converter 15a and the DC/AC inverter 15b are driven in response to commands from the system link inverter controller 15c (in response to commands from the fuel cell system controller 17). At the same time, the fuel pump 22 provided upstream of the desulfurizer 36 supplies fuel gas to the reforming apparatus 21 through the desulfurizer 36, whereby the fuel cell 11 starts power generation.

Then, the electric power from the fuel cell 11 is boosted in voltage at the DC/DC converter 15a and is supplied to the accessory DC/DC converter and hence to the fuel cell system controller 17 and the accessories 14. Further the electric power from the fuel cell 11 is supplied to the external loads 19 through the DC/DC converter 15a and the DC/AC inverter 15b.

When the fuel cell system starts power generation in this way, the inverter system 15 begins to operate as a whole, so that respective control boards in the inverter system 15 begin to generate heat. Thus, the air blower 31 arranged on the side wall 27b of the inverter box 27 starts its operation in order to cool the inverter system 15. Thus, clean air is drawn from the outside of the casing 70 through the cooling passage 80, and the drawn air moves in the interior space 27a of the inverter box 27 toward the air blower 31, in which course the drawn air cools the respective control boards as it changes heat with the respective control boards through direct or indirect contacts therewith. The air which has warmed up as a result of taking heat is led from the air blower 31 to the receiving space 52.

At this time, the air quantity α introduced from the air blower 31 to the receiving space 52 becomes a quantity which is left by subtracting from the air quantity Q introduced into the air inlet port 35 an air quantity β which is connected to, and is branched from, the mid portion of the duct 29 arranged upstream of the inverter box 27 to be supplied as oxidizer gas for the fuel cell 11 and another air quantity γ which, after being led into the inverter box 27, is branched and supplied as combustion air to the reforming apparatus 21 through the air outlet port 33 provided on the side wall 27c of the inverter box 27. Therefore, while the fuel cell system is generating electric power, the air from the air blower 31 is continued to be supplied at the quantity α to the receiving spaces 52, and the receiving space 52 is maintained at a positive pressure in dependence on clearances between the receiving space 52 and the outside space, so that it is possible to suppress the flowing of fuel gas from the outside of the receiving space 52 into the receiving space 52.

Further, because the internal pressure in the receiving space 52 becomes the positive pressure, at the clearance portions between the receiving space 52 and the outside, the air flow from the receiving space 52 toward the outside space is generated at a quantity which depends on the dimension of the clearances. Also at the clearance 54j in the through hole 45 under the breaker 51 which is arranged in the manipulation section space 59 provided at the upper part on the right side in the receiving space 52, an air flow which depends on the dimension of the clearance 54j flows into the maintenance space 53 which is provided in separation from the receiving space 52 to be located under the manipulation section space 59. Therefore, since the air around the breaker 51 also flows out together with that stream, it is possible to reduce the likelihood that even if fuel gas leaks in the maintenance space 53 at the worst, the leaked fuel gas flows toward the breaker 51 and remains therearound.

Then, the air flowing into the maintenance space 53 causes the internal pressure of the maintenance space 53 to rise. Because the internal pressure rises, the air in the maintenance space 53 passes through a space between the outer side surface of the vertical wall 54k, forming the right side surface of the manipulation section space 59 which is over the maintenance space 53, and the inner side surface of the right side surface 58a of the maintenance panel 58 to rise in pressure and is rapidly discharged to the atmosphere through respective clearance portions 53a between the lower surface of the upper panel 55 and the upper end of the maintenance panel 58. Further, the maintenance panel 58 is detachably provided on the casing 70, and when replacements are required of the parts received in the maintenance space 53, it is easily possible to deal with such the replacements by detaching the maintenance panel 58.

As is clear from the foregoing description, in the first embodiment, the cooling air which is introduced by the air blower 31 to the cooling passage 80 from the outside of the casing 70 cools the inverter system 15 and then is led to the receiving space 52 in the interior of the casing 70. Thus, the pressure in the receiving space 52 becomes higher than the atmospheric pressure, and the air in the receiving space 52 flows outside through the clearances being discharge passages provided on the casing 70, so that it is possible to reduce the likelihood that fuel gas is drawn by the casing 70 from the outside and remains in the receiving space 52 in the interior of the casing 70.

Further, in the first embodiment, the discharge passage 54j for discharging the air in the manipulation section space 59 to the maintenance space 53 is provided on the partition wall 54 which isolates the manipulation section space 59 with the breaker 51 arranged therein of the receiving space 52 in the interior of the casing 70 and the maintenance space 53 receiving the desulfurizer 36 for removing odor ingredient in the fuel gas. Thus, it is possible to make the air flow from the manipulation section space 59 to the maintenance space 53. Accordingly, even if at the worst, fuel gas leaks from the desulfurizer 36 and the fuel gas pipe and remains in the maintenance space 53, it is possible to reduce the likelihood that the fuel gas is drawn into the manipulation section space 59.

Furthermore, in the first embodiment, since the manipulation section space 59 with the breaker 51 arranged therein is provided over the maintenance space 53 which receives the desulfurizer 36 for removing odor ingredient in the fuel gas, the manipulation of the breaker 51 at the time of maintenance and the protection of the breaker becomes easy. In addition, although the maintenance space 53 is covered with the maintenance panel 58 which is detachably attached to the casing 70, the air flow from the manipulation section space 59 to the maintenance space 53 makes it possible to reduce the likelihood that fuel gas remains around the breaker even if such fuel gas leaks from the desulfurizer 36 at the worst.

Next, a second embodiment will be described with reference to FIG. 5. The second embodiment will be described only with respect to differences from the first embodiment. Since other constructions are the same as those in the first embodiment, the same components will be designated by the same reference numerals, and description will be omitted of such the same components. As shown in FIG. 3, the first embodiment takes the construction that the cooling air which is introduced by the operation of the air blower 31 from the outside of the casing 70 through the cooling passage 80 is directed to pass through the interior space 27a of the inverter box 27 while cooling the inverter system 15 and then is led into the receiving space 52 to keep the pressure in the receiving space 52 higher than the atmospheric pressure. However, as shown in FIG. 5, the second embodiment takes the construction that ventilation air which is introduced by an air blower 32 from the outside of a casing 73 through a ventilation passage 90 is directly led to a receiving space 61 to keep the pressure in the receiving space 61 higher than the atmospheric pressure. In this case, the cooling of the inverter system 40 received in the inverter box 38 is carried out in such a manner that an air blower 42 arranged at a lower part on a side wall 38b of an inverter box 38 is operated to draw the air in the receiving space 61 from an intake port 46 provided at an upper portion of a side wall 38c of the inverter box 38 and that the drawn air moves in the interior space 38a of the inverter box 38 toward the air blower 42. Further, with respect to combustion air toward a reforming apparatus 47, unlike the first embodiment wherein the air led into the inverter box 27 is branched to be drawn by the air pump 24, the air in the receiving space 61 is directly drawn by the operation of an air pump 49 and is supplied to a burner 48 of a reforming apparatus 47 to be burnt thereat. The gas having been burnt at the burner 48 is exhausted outside through an exhaust pipe 62 connected to an exhaust port of the reforming apparatus 47. The aforementioned respects are differences from the first embodiment, and the similar effects as those in the first embodiment can be expected in the aforementioned construction.

Although the maintenance panel 58 is provided detachably, it may be able to open and close like a door.

### INDUSTRIAL APPLICABILITY

A fuel cell system according to the present invention has an industrial applicability as a fuel cell system for stationary installation or the like which system is excellent in reliability because, by keeping the interior of a casing higher in pressure than the atmospheric pressure, it is possible to ventilate the interior of the casing satisfactorily and to suppress the drawing of combustible gas from the outside of the casing.

1-8. (canceled)

9. A fuel cell system comprising:
a reforming apparatus for generating reformed gas from fuel gas;
a fuel cell capable of generating electric power with reformed gas and oxidizer gas to supply output electric power to internal loads of the fuel cell system and external loads;
a cooling passage opening to the outside of a casing for leading cooling air which cools an interior of the casing, into a receiving space in the interior of the casing through an inverter system;
an air blower for introducing cooling air from the outside of the casing to the cooling passage; and
a breaker for cutting off a circuit to a power line when the fuel cell system falls in abnormality or is to be subjected to maintenance;
wherein:
the casing receives the reforming apparatus, the fuel cell, the inverter system, the air blower, and the breaker in the receiving space; and
cooling air introduced by the air blower from the outside of the casing is led to the receiving space after cooling the inverter system, whereby the pressure in the receiving space is kept higher than the atmospheric pressure.

10. A fuel cell system comprising:
a reforming apparatus for generating reformed gas from fuel gas;
a fuel cell capable of generating electric power with reformed gas and oxidizer gas to supply output electric power to internal loads of the fuel cell system and external loads;
a ventilation passage opening to the outside of a casing for leading ventilation air which ventilates an interior of the casing, into a receiving space in the interior of the casing;
an air blower for introducing ventilation air from the outside of the casing to the ventilation passage; and
a breaker for cutting off a circuit to a power line when the fuel cell system falls in abnormality or is to be subjected to maintenance;
wherein:
the casing receives the reforming apparatus, the fuel cell, the air blower, and the breaker in the receiving space; and
ventilation air introduced by the air blower from the outside of the casing is led to the receiving space, whereby the pressure in the receiving space is kept higher than the atmospheric pressure.

11. The fuel cell system as set forth in claim 9, wherein one end portion of the receiving space is made as a manipulation section space with the breaker arranged therein, a maintenance space receiving a desulfurizer for removing odor ingredient in the fuel gas is formed at the one end portion in the interior of the casing to be adjacent to the manipulation section space in isolation from the receiving space, and a partition wall isolating the manipulation section space and the maintenance space is provided with a discharge passage for discharging the air in the manipulation section space to the maintenance space.

12. The fuel cell system as set forth in claim 11, wherein the manipulation section space is arranged over the maintenance space and a maintenance panel covering the maintenance space is provided on the casing to be detachable or able to open and close.

13. The fuel cell system as set forth in claim 10, wherein one end portion of the receiving space is made as a manipulation section space with the breaker arranged therein, a maintenance space receiving a desulfurizer for removing odor ingredient in the fuel gas is formed at the one end portion in the interior of the casing to be adjacent to the manipulation section space in isolation from the receiving space, and a partition wall isolating the manipulation section space and the maintenance space is provided with a discharge passage for discharging the air in the manipulation section space to the maintenance space.

14. The fuel cell system as set forth in claim 13, wherein the manipulation section space is arranged over the maintenance space and that a maintenance panel covering the maintenance space is provided on the casing to be detachable or able to open and close.

15. The fuel cell system as set forth in claim 9, wherein the cooling passage comprises:
an air inlet port opening to the outside of the casing;
an interior space in the inverter box with the inverter system received therein; and
a duct connecting the air inlet port and the interior space in the inverter box:
wherein the air blower for introducing the cooling air to the cooling passage is provided on a wall surface of the inverter box in communication with the interior space of the inverter box.

16. The fuel cell system as set forth in claim 15, further comprising:
a branch passage branched from a mid portion of the duct on the cooling passage and including a cathode blower for supplying as oxidizer gas a part of the cooling air to an air electrode of the fuel cell; and
a passage branched from the interior space of the inverter box and provided with an air pump for supplying as combustion air a part of the cooling air to the reforming apparatus.

17. The fuel cell system as set forth in claim 10, wherein the ventilation passage comprises:
an air inlet port opening to the outside of the casing; and
a duct connected to the air inlet port and opening to the receiving space in the casing;
wherein the air blower for introducing the ventilation air to the ventilation passage is provided at an opening portion in the receiving space of the duct.

18. The fuel cell system as set forth in claim 17, further comprising:
a branch passage branched from a mid portion of the duct on the ventilation passage and including a cathode blower for supplying as oxidizer gas a part of the ventilation air to an air electrode of the fuel cell;
an intake port and an air blower arranged on wall surfaces of the inverter box and communicating with the interior space in the inverter box for introducing the air in the receiving space to cool the inverter system; and
an air pump for introducing the air in the receiving space as combustion air into the reforming apparatus.
